(19) United States
(12) Patent Application Publication
(10) Pub. No.: US 2011/0320474 A1
(43) Pub. Date: Dec. 29, 2011

(54) Availability of Database Objects During Database Operations

(75) Inventors: Naresh K. Chainani, Beaverton, OR (US); Michael J. Winer, Markham (CA); Liping Zhang, Beaverton, OR (US)

(73) Assignee: INTERNATIONAL BUSINESS MACHINES CORPORATION, Armonk, NY (US)

(21) Appl. No.: 12/822,215

(22) Filed: Jun. 24, 2010

(51) Int. Cl. G06F 17/30

(52) U.S. Cl. 707/769; 707/803; 707/E17.005; 707/E17.014

(57) ABSTRACT

A method, computer program product, and system for providing access to a database object during modification of that object. Upon receipt of a data definition language (DDL) operation specifying a modification to the database object, currently executing database transactions are invalidated in a two-step process of a soft invalidation followed by a hard invalidation. The soft invalidation permits the current database transactions to continue executing while modifying the logical structure of the database object in accordance with the DDL operation, and the hard invalidation waits for the database transactions started prior to the DDL operation to finish execution before modifying the physical structure of the database object in accordance with the DDL operation. After the modification to the logical structure is complete, new database transactions are allowed to execute against the modified database object, thus improving the availability of the object while it is being modified.

### BACKGROUND

1. Technical Field

The present invention relates generally to database systems, and more particularly to methods and systems for improving the availability of database objects during database operations.

2. Discussion of Related Art

In today's global economy, the ability of an enterprise to efficiently store, update, and use information can be critical to the enterprise's ability to serve its customers and compete in the marketplace. This information is often stored in databases, in the form of database objects such as tables, indices, or stored queries, and the enterprise's ability to carry out its business may depend on the continual availability of these database objects. The database objects may be shared among multiple processes, for example multiple queries may execute against a particular database object concurrently, but certain processes such as operations that alter the database object may need exclusive access to the database object in order to perform their function. To provide this exclusive access, a database object being modified is typically taken offline for a period of time, for example during a periodic maintenance window, to allow the modifications to proceed without conflicting with any executing queries. A database object may be taken offline by waiting for all current queries or activity on the database object to stop, while disallowing any new activity on the object to start or compile. The increased global demand for information conflicts with the idea of a database being offline for long periods of time, however, as there may be no time during the day when there are not some demands for access to the database objects from somewhere around the world.

### BRIEF SUMMARY

Accordingly, embodiments of the present invention include a method, computer program product and a system for providing access to a database object during modification of that object comprising modifying a logical structure of a database object and allowing an executing first database transaction initiated against the database object prior to the modification to complete operation, enabling execution of a new database transaction against the modified database object in response to the modification, and modifying a physical structure of the modified database object in accordance with the modified logical structure in response to the completion of operation of the first database transaction.

The above and still further features and advantages of embodiments of the present invention will become apparent upon consideration of the following detailed description thereof, particularly when taken in conjunction with the accompanying drawings wherein like reference numerals in the various figures are utilized to designate like components.

### BRIEF DESCRIPTION OF THE SEVERAL VIEWS OF THE DRAWINGS

FIG. 1 is a block diagram illustrating an exemplary computing system according to an embodiment of the present invention.

FIG. 2 is a flowchart depicting an exemplary method for improving the availability of database objects during database operations according to an embodiment of the present invention.

FIG. 3 is a timeline depicting various steps of an exemplary method for improving the availability of database objects during database operations according to an embodiment of the present invention.

### DETAILED DESCRIPTION

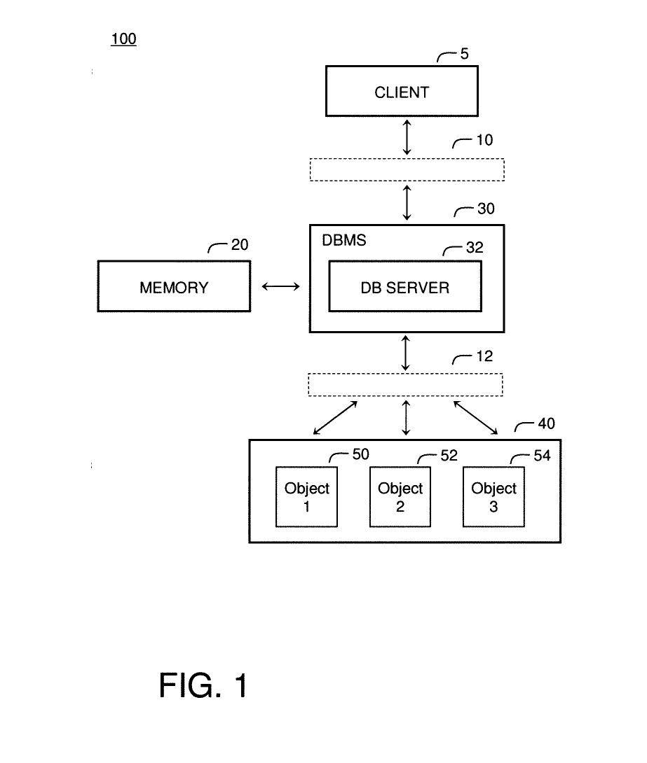

Referring now to the Figures, an exemplary computer system according to embodiments of the present invention is illustrated in FIG. 1. FIG. 1 shows a computer system 100 comprising a memory 20, database management system (DBMS) 30 comprising a database server 32, and data storage system 40 containing objects 50, 52, 54, all of which are connected over networks 10, 12 to each other and to clients 5. The system 100 may include additional servers, clients, and other devices not shown, and individual components of the system may occur either singly or in multiples, for example, there may be more than one data storage area in the system. The system 100 may also be a node, for example a node in a computing cluster, which is connected to other nodes by suitable means, for example via a network.

The computer system 100 may be implemented in the form of a processing system, or may be in the form of software. The computer system 100 may be implemented by any quantity of conventional or other computer systems or devices (e.g., computer terminals, personal computers (e.g., IBM-compatible, Apple MacIntosh, tablet, laptop, etc.), etc.), cellular telephones, personal data assistants (e.g., Palm Pre, Droid, iPhone, etc.), etc., and may include any commercially available operating system (e.g., AIX, Android, Linux, OSX, Sun Solaris, Unix, Windows, etc.) and any commercially available or custom software (e.g., browser software, communications software, word processing software, etc.). These systems may include types of displays and input devices (e.g., keyboard, mouse, voice recognition, etc.) to enter and/or view information. If embodied in software (e.g., as a virtual image), the computer system 100 may be available on a recordable medium (e.g., magnetic, optical, floppy, DVD, CD, other non-transitory medium, etc.) or in the form of a carrier wave or signal for downloading from a source via a communication medium (e.g., bulletin board, network, LAN, WAN, Intranet, Internet, etc.).

Generally, clients 5 provide an interface to the functions provided by the DBMS 30, for example, mechanisms for querying the databases, updating or maintaining the databases, etc. The end-user clients 5 may be implemented by any quantity of conventional or other computer systems or devices, cellular telephones, personal data assistants, etc., and may include any commercially available operating system and any commercially available or custom software. These systems may include types of displays and input devices (e.g., keyboard, mouse, voice recognition, etc.) to enter and/or view information.

Networks 10, 12 may be implemented by any quantity of any suitable communications media (e.g., WAN, LAN, Internet, Intranet, wired, wireless, etc.). The computer systems of the present invention embodiments may include any conventional or other communications devices to communicate over the networks via any conventional or other protocols, and may utilize any type of connection (e.g., wired, wireless, etc.) for access to the network. It is understood that any of the client 5, memory 20, DBMS 30, and data storage system 40 may be local to one or more components of system 100, or may be remote from and in communication with one or more other components of system 100 via one or more networks 10, 12.

Memory 20 may be implemented by any conventional or other memory or storage device, and may be volatile (e.g., RAM, cache, flash, etc.), or non-volatile (e.g., ROM, hard-disk, optical storage, etc.). The memory may include any suitable storage capacity. The DBMS 30 may be any suitable database management system, and may be a Master Data Management system such as IBM InfoSphere Master Data Management Server, Microsoft SQL Server 2008 R2 Master Data Services, or Sun Master Data Management (MDM) Suite, for example. In the depicted embodiment, the DBMS comprises a database server 32.

Data storage system 40 may be implemented by any quantity of any type of conventional or other databases (e.g., network, hierarchical, relational, object, etc.) or storage structures (e.g., files, data structures, web-based storage, disk or other storage, etc.) and may comprise an enterprise data source (e.g., DB2, Oracle, IBM Enterprise Content Management (ECM) systems, ERP systems, etc.), personal and intra-organization data sources (e.g., spreadsheets (e.g., Microsoft Excel), databases (e.g., Microsoft Access, MySQL, Sharepoint, Quickr, XML, etc.)), or web-based data sources such as public databases (e.g., tax records, real estate records, court documents, etc.) and the like. The data storage system may store any desired information arranged in any fashion (e.g., tables, hierarchical, relations, objects, etc.), and may store additional information such as metadata in addition to documents. In the depicted embodiment, the data storage system 40 comprises three database objects 50, 52, 54 which may be, for example, tables, indices, or stored queries.

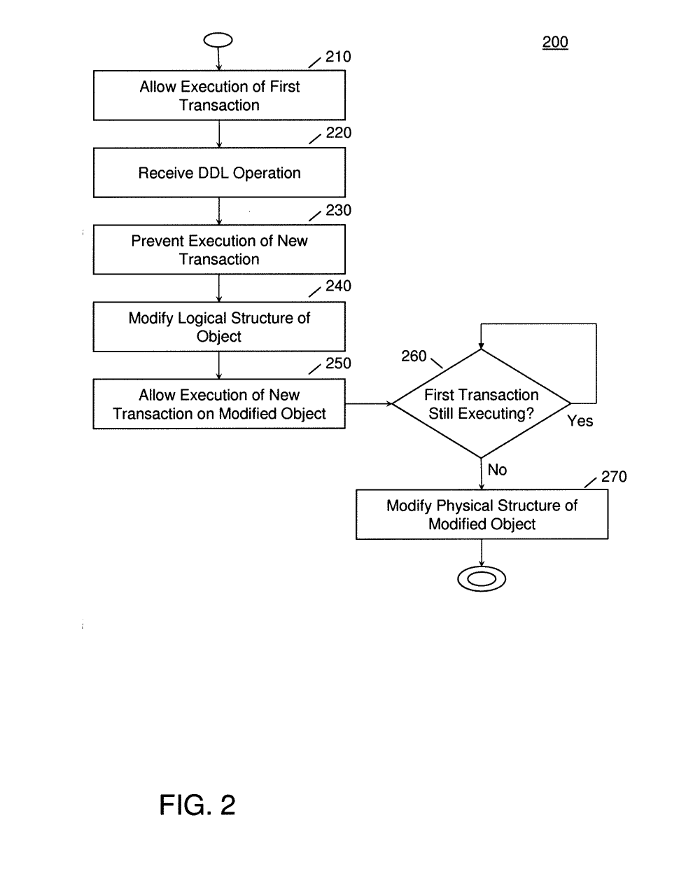

Referring now to FIG. 2, the system that has been previously described, and particularly the database server 32 may perform the steps of FIG. 2, in which reference numeral 200 generally designates a flow chart depicting a process for improving the availability of database objects during database operations. In step 210, a first database operation (e.g., a query) initiated against a database object is allowed to execute. In step 220, a DDL operation, which specifies an alteration to the database object, is received. Data Definition Language (DDL) operations are database operations that define or alter a database object such as a table, index, or stored query, for example, CREATE, ALTER, DROP, and TRUNCATE operations in SQL. For illustrative purposes, the process 200 is described with reference to an exemplary ALTER TABLE DETACH PARTITION command, which is a type of DDL operation in which data is removed or purged from a table.

In step 230, the compiled instance of the first operation is soft invalidated, which permits the first operation to continue executing on the table containing the data to be purged while preventing reuse of that particular compiled instance, e.g., new operations using the compiled instance are prevented from executing on the table containing the data to be deleted. In step 240, the DDL operation modifies the logical structure of the database object, for example to indicate that the data to be purged is no longer in the table, but at this time does not actually modify the physical structure to remove the data because the first operation may be accessing or need to access the data. In step 250, a new database operation (e.g., a query) initiated against the database object is allowed to execute. This new database operation sees the modified logical structure of the database object, and thus is unaware that the data to be purged is still physically present in the database object. The first database operation is then hard invalidated in step 260, that is, the compiled instance of the first operation is removed after the system determines that the first database operation has completed execution, and if not, the system waits until it has completed. Then in step 270 the physical structure of the database object is modified to physically remove the data to be purged.

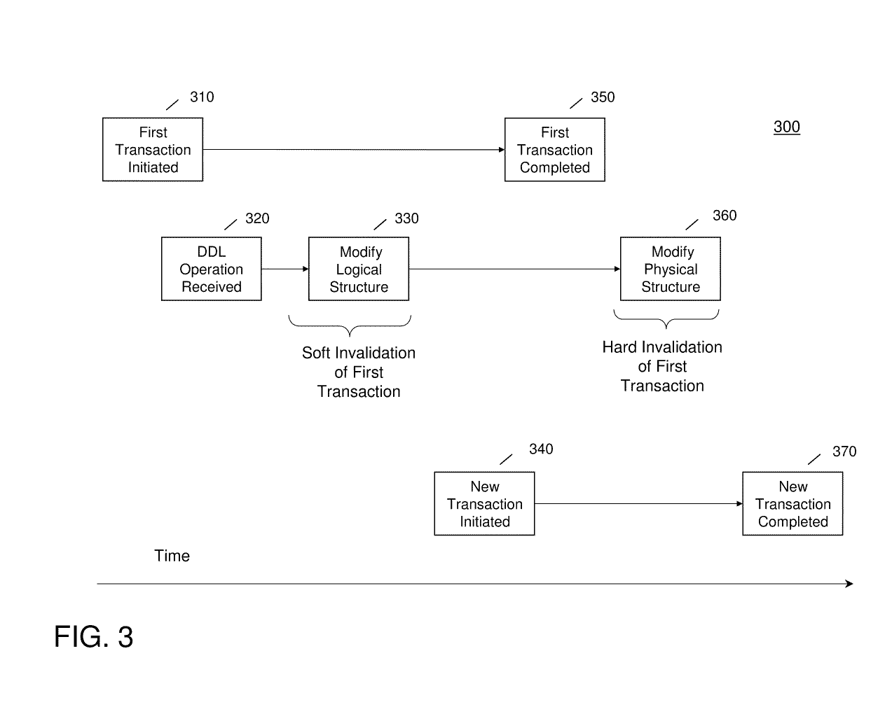

In FIG. 3, reference numeral 300 generally designates a timeline illustrating various steps of an exemplary method for improving the availability of database objects during database operations, that may be performed by the previously described system, and particularly the database server 32. At a first time point 310, a first database operation (e.g., a query) is initiated against a database object. At a later time point 320, a DDL operation that specifies an alteration of the database object, such as an ALTER TABLE DROP COLUMN command is issued and received. The compiled instance of the first database operation is then soft invalidated, which prevents new database operations from reusing that particular compiled instance of the database object, but allows the execution of the first database operation to continue.

At time point 330, the system modifies the logical structure of the database object, and after this time, new database operations are allowed to initiate against the modified database object, for example at time point 340. Because the new database operation sees only the modified logical structure of the database object, the new database operation is unaware that the data to be purged is still physically present in the database object. At time point 350, the first database operation completes execution, and is hard invalidated. In step 360, the physical structure of the database object is modified to physically remove the data to be purged. The completion of the first transaction at time point 350, the hard invalidation, and the modification of physical structure at time point 360 do not interrupt the execution of the new database operations initiated at time point 340. At a later time point 370, the new database operation completes execution.

The described first database operation and new database operation may individually be selected from any suitable database operation, for example, a query, a DDL operation, or a DML operation. Data Manipulation Language (DML) operations are database operations that manage data within schema objects, for example, INSERT, DELETE, SELECT, or UPDATE operations in SQL. Although the depicted examples describe and illustrate a single first operation, there may be multiple “first” database operations executing prior to the receipt of the DDL operation, each of which undergoes the two-step soft and hard invalidation of the present methods. Similarly, although the depicted examples describe and illustrate a single new database operation, there may be multiple new database operations that are allowed to execute after the soft invalidation process has completed.

Accordingly, as compared to conventional systems that prevent a new query from executing until after the completion of a first query and an update of the database object, the present embodiments improve availability of database objects during database operations by breaking the invalidation of compiled dependencies (e.g., queries) into two steps. From the application perspective, the described two-step invalidation process renders the database object available even when it is undergoing modification, thus reducing data downtime and reducing or eliminating the need for a data maintenance window.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable medium may be, for example, but is not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device. Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

It is to be understood that the software for the computer systems of the present invention embodiments may be implemented in any desired computer language and could be developed by one of ordinary skill in the computer arts based on the functional descriptions contained in the specification and flow charts illustrated in the drawings. By way of example only, the software may be implemented in the C#, C++, Python, Java, or PHP programming languages. Further, any references herein of software performing various functions generally refer to computer systems or processors performing those functions under software control.

The computer systems of the present invention embodiments may alternatively be implemented by any type of hardware and/or other processing circuitry. The various functions of the computer systems may be distributed in any manner among any quantity of software modules or units, processing or computer systems and/or circuitry, where the computer or processing systems may be disposed locally or remotely of each other and communicate via any suitable communications medium (e.g., LAN, WAN, Intranet, Internet, hardwire, modem connection, wireless, etc.).

Aspects of the present invention are described with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks. The computer program instructions may also be loaded onto a computer, other programmable data processing apparatus, or other devices to cause a series of operation steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

A processing system suitable for storing and/or executing program code may be implemented by any conventional or other computer or processing systems preferably equipped with a display or monitor, a base (e.g., including the processor, memories and/or internal or external communications devices (e.g., modem, network cards, etc.) and optional input devices (e.g., a keyboard, mouse or other input device)). The system can include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution. Input/output or I/O devices (including but not limited to keyboards, displays, pointing devices, etc.) can be coupled to the system either directly or through intervening I/O controllers. Network adapters may also be coupled to the system to enable the system to become coupled to other processing systems or remote printers or storage devices through intervening private or public networks. Modems, cable modem and Ethernet cards are just a few of the currently available types of network adapters.

The flowchart and block diagrams in the Figures illustrate the architecture, functionality, and operation of possible implementations of systems, method and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the Figures. For example, two blocks shown in succession may, in fact, be executed substantially concurrently, or the blocks may sometime be executed in the reverse order, depending on the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

What is claimed is:

1. A method for providing access to a database object during modification of that object comprising:
modifying a logical structure of a database object and allowing an executing first database transaction initiated against the database object prior to said modification to complete operation;
in response to said modification, enabling execution of a new database transaction against the modified database object; and,
in response to the completion of operation of the first database transaction, modifying a physical structure of the modified database object in accordance with the modified logical structure.

2. The method of claim 1, further comprising, in response to said modification of the logical structure of the database object, enabling execution of a plurality of new database transactions against the modified database object.

3. The method of claim 1, wherein the first database transaction is a query, and the second database transaction is selected from the group consisting of a query, a data definition language (DDL) operation, and a data manipulation language (DML) operation.

4. The method of claim 1, wherein the first database transaction is selected from the group consisting of a query, a data definition language (DDL) operation, and a data manipulation language (DML) operation, and the second database transaction is a query.

5. The method of claim 1, wherein the database object is a table.

6. The method of claim 1, wherein the database object is an index.

7. A computer program product comprising a computer useable medium having a computer readable program, wherein the computer readable program when executed on a computer causes the computer to:
modify a logical structure of a database object and allow an executing first database transaction initiated against the database object prior to said modification to complete operation;
in response to said modification, enable execution of a new database transaction against the modified database object; and,
in response to the completion of operation of the first database transaction, modify a physical structure of the modified database object in accordance with the modified logical structure.

8. The computer program product of claim 7, wherein the computer readable program when executed on a computer further causes the computer to:
in response to said modification of the logical structure of the database object, enable execution of a plurality of new database transactions against the modified database object.

9. The computer program product of claim 7, wherein the first database transaction is a query, and the second database transaction is selected from the group consisting of a query, a data definition language (DDL) operation, and a data manipulation language (DML) operation.

10. The computer program product of claim 7, wherein the first database transaction is selected from the group consisting of a query, a data definition language (DDL) operation, and a data manipulation language (DML) operation, and the second database transaction is a query.

11. The computer program product of claim 7, wherein the database object is a table.

12. The computer program product of claim 7, wherein the database object is an index.

13. The computer program product of claim 7, wherein the computer program product is stored on a computer useable optical storage medium.

14. The computer program product of claim 7, wherein the computer program product is stored on a hard disk.

15. A system comprising:
a memory having a database object stored therein; and
a processor configured with logic to
modify a logical structure of the database object and allow an executing first database transaction initiated against the database object prior to said modification to complete operation;
in response to said modification, enable execution of a new database transaction against the modified database object; and,
in response to the completion of operation of the first database transaction, modify a physical structure of the modified database object in accordance with the modified logical structure.

16. The system of claim 15, wherein the processor is further configured with the logic to:
in response to said modification of the logical structure of the database object, enable execution of a plurality of new database transactions against the modified database object.

17. The system of claim 15, wherein the first database transaction is a query, and the second database transaction is selected from the group consisting of a query, a data definition language (DDL) operation, and a data manipulation language (DML) operation.

18. The system of claim 15, wherein the first database transaction is selected from the group consisting of a query, a data definition language (DDL) operation, and a data manipulation language (DML) operation, and the second database transaction is a query.

19. The system of claim 15, wherein the database object is a table.

20. The system of claim 15, wherein the database object is an index.
